(19) United States
(12) Patent Application Publication
(10) Pub. No.: US 2003/0099584 A1
(43) Pub. Date: May 29, 2003

(54) Aqueous ozone generator with reverse osmosis or deionization function

(76) Inventors: Liang-Kuang Diang, Jhong He City (TW); Kuo-Hsin Ho, Sanchung City (TW)

Correspondence Address: RABIN & BERDO, P.C., Suite 500, 1101 14th Street, N.W., Washington, DC, 20005, US

(21) Appl. No.: 09/994,512

(22) Filed: Nov. 28, 2001

(51) Int. Cl. B01J 19/08

(52) U.S. Cl. 422/186.07; 422/186.08

(57) ABSTRACT

An aqueous ozone generator with reverse osmosis or deionization function includes an ozone generator and an ozone monitor connected with the outlet end of a reverse osmosis circuitry. The reverse osmosis circuitry can be replaced by a deionization circuitry. The ozone generator produces ozone which is then diffused to the pure water making the aqueous ozone solution with ozone level above 1 ppm. As a disinfectant, aqueous ozone solution is applied to water for washing food, dishware, wound and medical devices.

### BACKGROUND OF THE INVENTION

1. Field of the Invention

The present invention related to an aqueous ozone generator with reverse osmosis or deionization function, especially to an aqueous ozone generator that produces aqueous ozone to be used as a disinfectant and as an oxidant. The ozone is easily reduced into oxygen and water, both are harmless to human bodies. The aqueous ozone solution can be applied to the sterilization of the food, tableware, wound or medical apparatus.

2. Description of the Prior Art

Ozone exists in the earth's atmosphere in gas form. Compared to hydrogen peroxide, alcohol, or iodine, ozone is a more potent oxidizing agent. As an extremely effective oxidizer and having unstable molecular structure, when ozone comes into contact with other molecular, it's easy to oxidize them and itself is reduced to oxygen, which is harmless. Therefore, as a disinfectant, ozone can eliminate microorganism quickly without the side effect of residual. Ozone can also be used to degrade the residual pesticide on food.

Currently, ozone is common used in purifying the air and removing odors. When aqueous borne ozone is applied to the disinfection of water for washing food, dishware, wound or medical devices, the easily decomposition of the ozone becomes a problem. Ozone gas is easy to diffuse in the air. General tape water includes a lot of contaminate and chemical disinfectants such as bleaching agent or chloride. If only a little amount of ozone diffused into water, ozone is easy to act as a counteragent being reduced into oxygen. Thus the effect of disinfection or removing the contaminate pesticide residual has been effected. And there is a need to have a device that produces stable concentrated aqueous ozone.

### SUMMARY OF THE INVENTION

It is therefore a primary object of the present invention to provide an aqueous ozone generator with reverse osmosis or deionization function. At the outlet end of a reverse osmosis circuitry (or a deionization circuitry), an ozone generator and an ozone monitor are connected in series. The ozone generator turns pure water or deionized water into aqueous ozone solution with the ozone level above 1 ppm (parts per million). Because ozone can quickly react with many organic and inorganic chemicals in solution, pure water is used avoid such kind of problem. The aqueous ozone solution is applied to water for washing food, dishware, wound or medical devices as a disinfectant.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a schematic drawing of the present invention;

FIG. 2 is a schematic drawing showing the components of the reverse osmosis circuitry;

FIG. 3 is a schematic drawing showing the components of the ozone generator;

FIG. 4 is a schematic drawing showing the components of the deionization circuitry;

FIG. 5 is a schematic drawing of a further embodiment of the present invention.

### DETAILED DESCRIPTION OF THE PREFERRED EMBODIMENT

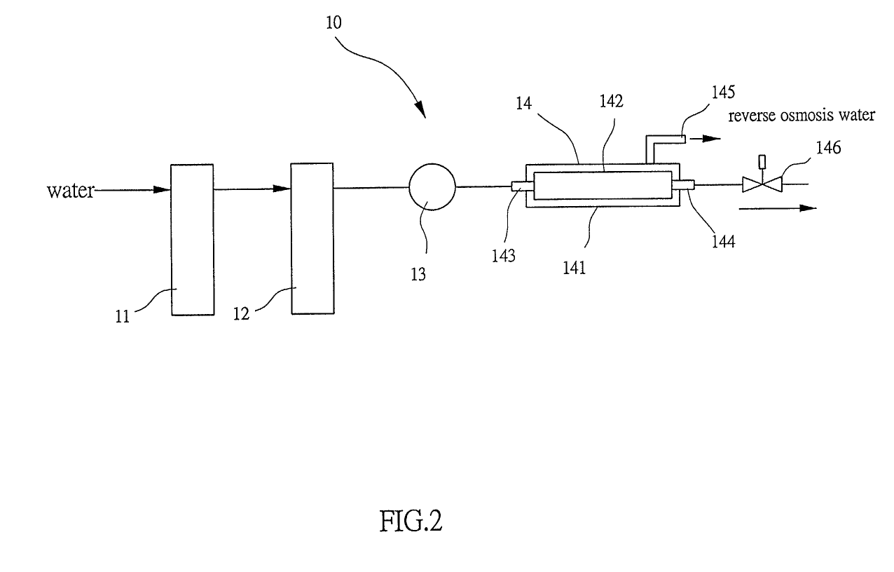

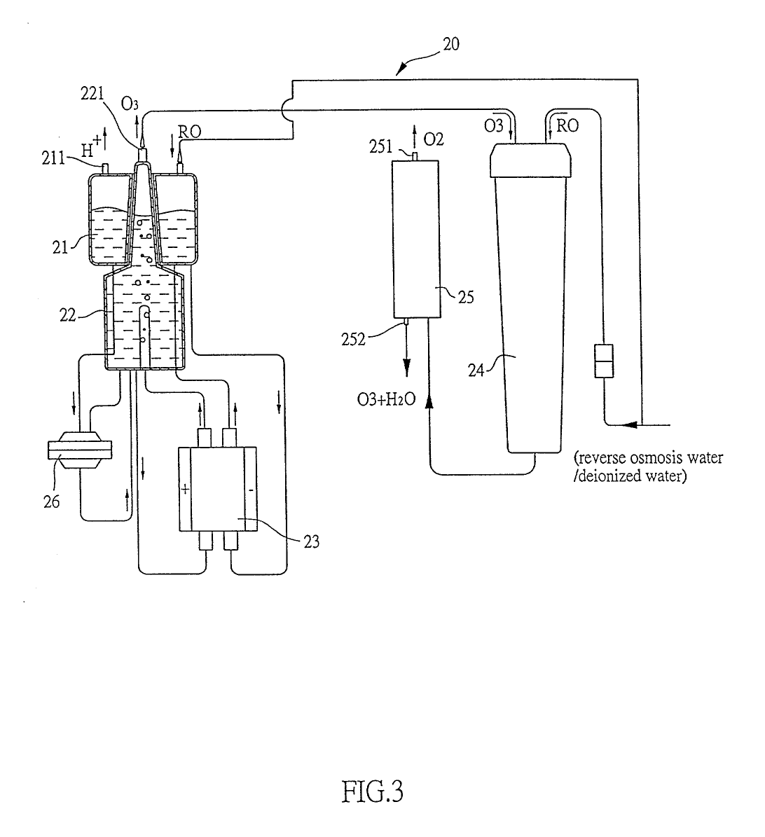

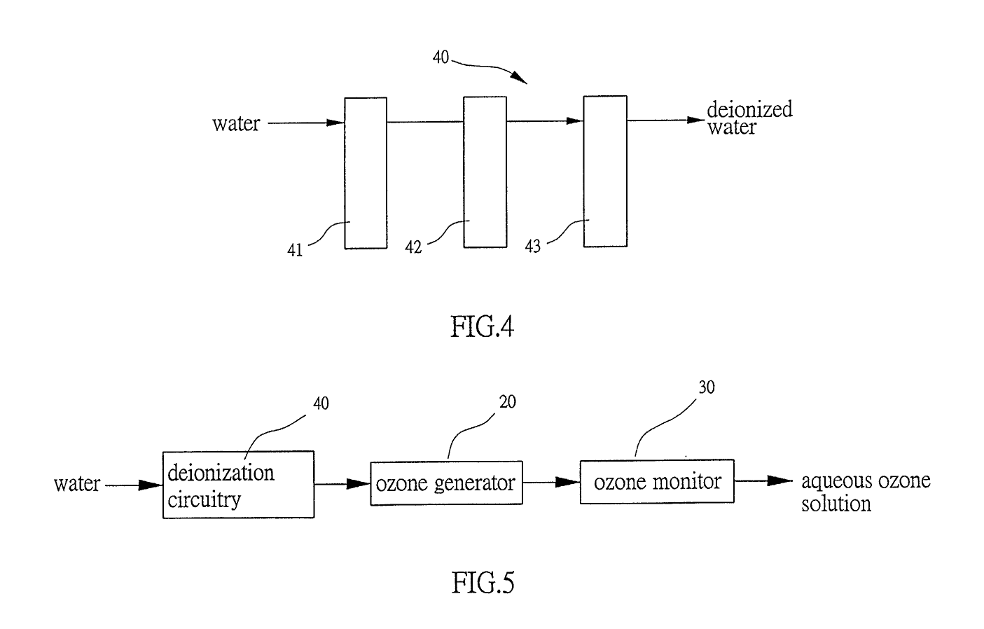

The present invention includes a reverse osmosis circuitry 10, an ozone generator 20, and an ozone monitor 30, all connected in series. Refer to FIG. 2, the input end of a filter 11 is connected with a water faucet (water supply) while the output end thereof is joined with a carbon filter tube 12. A pump 13 for creating pressure is disposed between the carbon filter tube 12 and a reverse osmosis membrane tube 14. The reverse osmosis membrane tube 14 is composed of an outer tube 141, an inner membrane tube 142, a water inlet port 143, a waste outlet port 144 and a pure water outlet port 145. The inner membrane tube 142 is connected with the water inlet port 143 and the waste outlet port 144 on two ends respectively. A pressure control valve 146 is linked to the waste outlet port 144 in order to produce the osmosis pressure of the inner membrane tube 142. When the pump 13 compresses, the water flows into the inner membrane tube 142 through the water inlet port 143. Part of the water penetrates through the pores on the inner membrane tube 142 while the large molecular material such as contaminate or bacteria retains in the inner membrane tube 142 and then is drained through the waste outlet port 144 to be run off or recycled. The water infiltrates from the inner membrane tube 142 is pure water that flows through the pure water outlet port 145.

The water outlet port 145 of the reverse osmosis membrane tube 14 in the reverse osmosis circuitry 10 is connected with an ozone generator 20 and an ozone monitor 30 in sequence. The ozone generator 20 includes a negative pole tank 21, positive pole tank 22, electrode 23, water-gas mixer 24, water-gas isolator 25 and a one-way valve 26. The pure water processed by the reverse osmosis circuitry 10 is filled into the negative pole tank 21 and is electrolyzed by the cathode of the electrode 23. The hydrogen ion inside the water is replaced by the anion. Then the water flows back to the negative pole tank 21 and the hydrogen gas is released through the hydrogen outlet 211. The water with higher oxygen concentration then convey through the one-way valve 26 into to the positive pole tank 22. By passing the anode of the electrode 23, the water is electrolyzed and ozone is produced. The ozone gas is transported through the oxygen outlet 221 and then is infused into the water-gas mixer 24 for being dissolved in pure water while the residual ozone undiffused is delivered out to the environment through the ozone outlet port 251 of he water-gas isolator 25. Because ozone can quickly react with many organic and inorganic chemicals in solution, pure water is used avoid such kind of problem. The aqueous ozone solution flows out from the water outlet port 252 is used for various kind of applications.

In order to precisely monitoring the ozone level, an ozone monitor 30 is installed on one end of the water outlet port 252 for ozone concentration monitoring and regulation. This is for safety. The ozone level is above 1 ppm (parts per million).

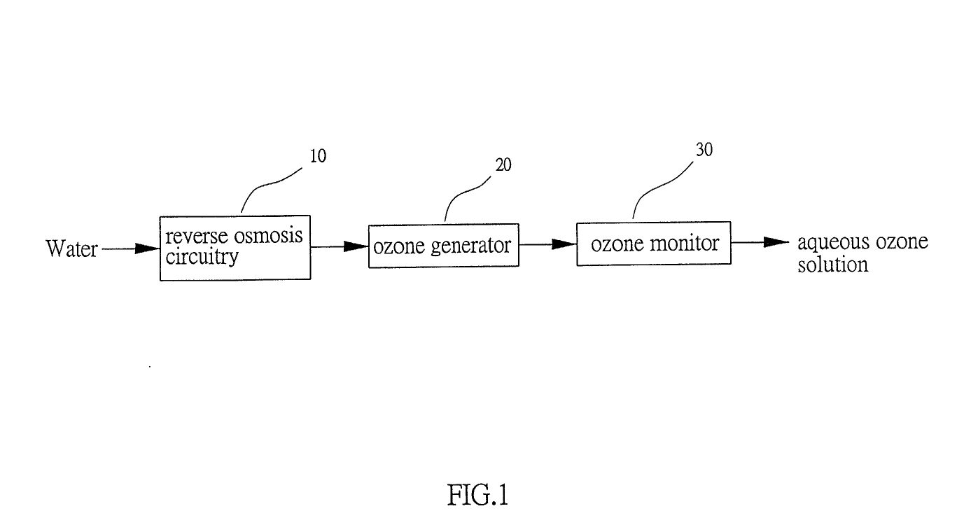

Refer to FIG. 1, the reverse osmosis circuitry 10 can be replaced by a deionization circuitry 40, as an embodiment showed in FIG. 5. The deionization circuitry 40 comprises a filter 41, a cation exchange column 42, an anion exchange column 43 connected in sequence. The input end of the filter 41 is connected to a water faucet (water supply) and the output end thereof is joined with the cation exchange column 42. The deionized water produced by the deionization circuitry 40 is transported to the ozone generator 20. In addition, the reverse osmosis circuitry 10 and the deionization circuitry 40 can be connected in series so as to form another embodiment.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claim.

What is claimed is:

1. An aqueous ozone generator with reverse osmosis function comprising a reverse osmosis circuitry having a water inlet port and a water outlet port, an ozone generator, and an ozone monitor, being connected in series; wherein the improvement is characterized in that said ozone generator and said ozone monitor is connected to the water outlet port of said reverse osmosis circuitry in series; whereby said ozone generator converts pure water into aqueous ozone solution with ozone level above 1 ppm.

2. An aqueous ozone generator with deionization function comprising a deionization circuitry having a water inlet port and a water outlet port, an ozone generator, and an ozone monitor, being connected in series; wherein the improvement is characterized in that said ozone generator and said ozone monitor is connected to the water outlet port of said deionization circuitry in series; whereby said ozone generator converts pure water into aqueous ozone solution with ozone level above 1 ppm.
